(19) United States
(12) Patent Application Publication
(10) Pub. No.: US 2004/0265546 A1
(43) Pub. Date: Dec. 30, 2004

(54) Pad for wireless optical mouse

(75) Inventor: Tim Brophy, San Mateo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Acco Brands, Inc.

(21) Appl. No.: 10/142,389

(22) Filed: May 8, 2002

(51) Int. Cl. B32B 23/02

(52) U.S. Cl. 428/192

(57) ABSTRACT

The present invention provides energy-saving pads for use with optical mice. The mouse pads of the present invention are particularly suitable for use with wireless optical mice. In some embodiments, optical mouse pads are constructed by peeling the backing from reflective sheeting, then applying a transparent layer to an exposed adhesive layer of the reflective sheeting. Some optical mouse pads are provided with wrist rests and/or anti-skid bases.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention relates generally to computer peripheral devices and more specifically to pads for optical input devices.

2. Description of the Prior Art

Optical input devices or “mice” have become increasingly popular in recent years. An optical mouse typically uses a light-emitting diode (“LED”) and an enclosed optical sensor to detect movement relative to a work surface. Because an optical mouse lacks the track ball and rollers of a conventional mouse, an optical mouse does not collect debris or require frequent cleaning in order to operate properly. Moreover, an optical mouse typically provides a more precise tracking of relative motion than a conventional mouse provides.

A conventional mouse is typically used with a mouse pad. Such a pad commonly has a top surface made of fabric or similar material with a sufficiently high coefficient of friction to engage the track ball of the conventional mouse and to minimize slipping of the track ball. Although an optical mouse may be (and often is) used with a conventional mouse pad, an optical mouse need not be used on a high-friction surface. Instead, optical mice may be used on a variety of surfaces which may be present on or near a desktop, such as a stack of paper, a pant leg or the desktop itself.

Recently, wireless optical mice have entered the stream of commerce. These devices have been quickly accepted by consumers, in part because of the intrinsic convenience of cordless operation. However, wireless optical mice are powered by batteries which must periodically be replaced.

The majority of conventional mouse pads have top surfaces which are dark in color and are not highly reflective. These dark surfaces require an optical mouse to operate at a relatively high power in order to track the movement of the mouse. Consequently, conventional mouse pads cause the batteries of wireless optical mice to be used quite rapidly. Moreover, operating the LED of an optical mouse at such relatively high power shortens the lifetime of the LED.

### SUMMARY OF THE INVENTION

The present invention provides a variety of pads for use with optical mice and also provides methods for manufacturing such pads. The optical mouse pads of the present invention cause optical mice to use less power than necessary for use with prior art pads. Therefore, these pads extend the life of the batteries used in wireless optical mice. In addition, optical mouse pads of the present invention cause an optical mouse to operate its LED at a relatively lower power, thereby extending the lifetime of the LED and the optical mouse.

According to some embodiments of the present invention, an optical mouse pad includes a first layer of reflective sheeting and a second layer attached to the first layer, the second layer being substantially transparent to light emitted by an optical mouse.

According to some embodiments of the present invention, an optical mouse pad includes a first layer of reflective sheeting having a first side designed to be an outer portion and a second adhesive side, and a second substantially transparent layer attached to the second side of the first layer.

The present invention also provides a method of fabricating a pad for use with an optical mouse from reflective sheeting comprising a first side designed to face incident light, a second side comprising an adhesive portion and a layer of backing attached to the second side, the method comprising the steps of removing the backing from the second side and attaching a substantially transparent layer to the second side.

Other features and advantages of the present invention will be understood upon reading and understanding the description of the preferred exemplary embodiments, found hereinbelow, in conjunction with reference to the drawings, in which like numerals represent like elements.

### BRIEF DESCRIPTION OF THE DRAWINGS

FIG. 1 is a perspective view of a wireless optical mouse and one embodiment of an optical mouse pad according to the present invention;

FIG. 2 is a cross-section of one embodiment of an optical mouse pad according to the present invention;

FIG. 3 illustrates a piece of reflective sheeting with a backing layer partially separated from an adhesive side;

FIG. 4 illustrates a step of applying a substantially transparent layer to an adhesive side of a piece of reflective sheeting; and

FIG. 5 is a perspective view of an optical mouse pad according to the present invention, wherein the top layer of the optical mouse pad varies laterally.

### DESCRIPTION OF SPECIFIC EXEMPLARY EMBODIMENTS

The majority of conventional mouse pads are relatively dark in color. However, test results have shown that an optical mouse pad having a reflective top surface and/or a relatively lighter-colored top surface improves the battery life and the LED life of a wireless optical mouse. Disposing a substantially transparent layer over the reflective and/or relatively lighter-colored top surface yields further improvements of this nature.

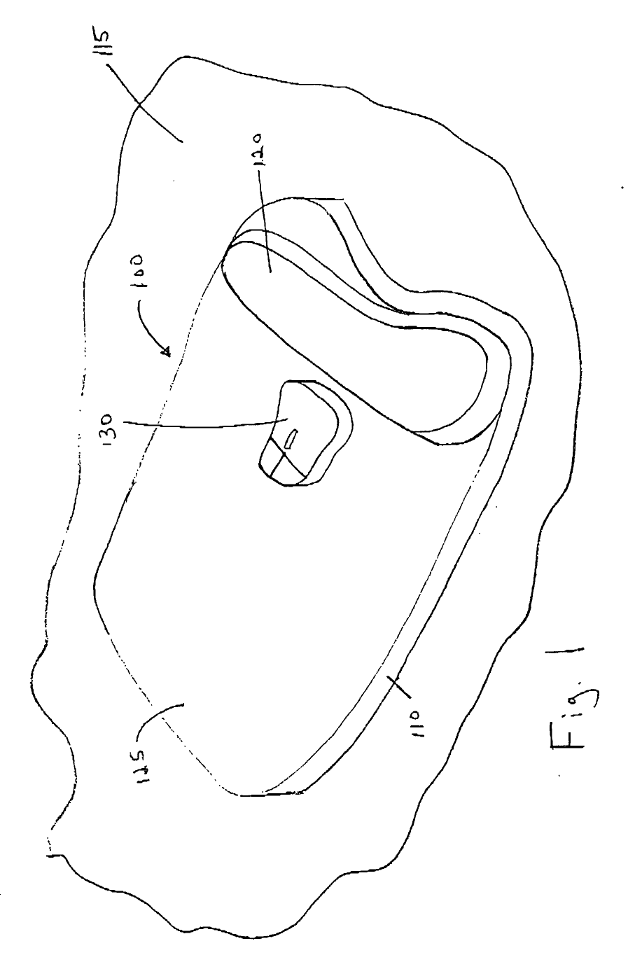

FIG. 1 illustrates one embodiment of an optical mouse pad of the present invention. Optical mouse pad 100 is not drawn to scale in FIG. 1: the thickness of optical mouse pad 100 has been exaggerated. Optical mouse pad 100 includes base 110, which is preferably made of rubber or a similar non-skid material. Base 110 is illustrated in contact with work surface 115. Here, work surface 115 is a portion of a desktop. Optical mouse 130, which is not part of optical mouse pad 100, is positioned on top layer 125.

In the embodiment illustrated in FIG. 1, optical mouse pad 100 includes wrist support 120. However, other embodiments of optical mouse pad 100 do not include wrist support 120. In preferred embodiments, wrist support 120 includes material which is deformable by the weight of a user's wrist, such as rubber, soft plastic, foam or gel. The surface of wrist support 120 is preferably formed of material which “breathes” and is pleasant to a user's touch, such as fabric, leather or similar material. Some embodiments of wrist support 120 are covered with the same material as that used to form top layer 125 and some embodiments of wrist support 120 are covered with a different material, or the same material in a different color.

Top layer 125 is formed of a wide variety of different materials and colors in various embodiments of optical mouse pad 100. In some embodiments of optical mouse pad 100, top layer 125 is formed of a fabric such as lycra. In preferred embodiments of optical mouse pad 100, if one side of the material used to make top layer 125 is more reflective than the other side, the more reflective side faces upwards, towards optical mouse 130. For example, in one embodiment of optical mouse pad 100, top layer 125 is formed of red lycra with the shiny side up. Other materials used to fabricate top layer 125 include, but are not limited to, Formica™, white board material and melamine shelving material.

In some embodiments of optical mouse pad 100, top layer 125 is formed of a material which is substantially transparent to the light used by an optical mouse. For example, many optical mice include a light-emitting diode which emits light in the red range of the visible spectrum. Accordingly, some embodiments of top layer 125 are substantially transparent to red light. Materials used to fabricate such embodiments of top layer 125 include, but are not limited to, polycarbonate, Mylar, LEXAN™ material, lacquer, polyurethane, acetate and plastics such as polyvinyl chloride.

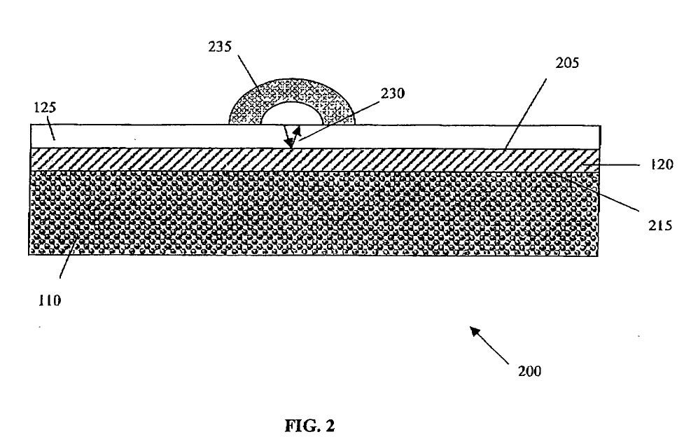

FIG. 2 is a cross-section of optical mouse pad 200. Again, the thickness of optical mouse pad 200 has been exaggerated to more clearly illustrate its layers. In the embodiment illustrated in FIG. 2, reflective layer 120 is disposed between base 110 and top layer 125. Although the embodiment of optical mouse pad 200 illustrated in FIG. 2 has 3 layers, optical mouse pad 200 may have any number of layers.

The layers of optical mouse pad 200 may include elements such as text, logos, holograms, or other functional or decorative elements. In some embodiments of optical mouse pad 200, ink, paint or other pigment-laden media are used to form decorative elements such as stars, planets, moons, characters, etc. In some such embodiments, phosphorescent paint is used to form the elements, causing optical mouse pad 200 to glow in the dark. When optical mouse pad 200 is in use, chemical bonds in the phosphorescent paint absorb energy from both ambient light and light from the optical mouse. When the intensity of ambient light is reduced below a threshold level, the elements formed in phosphorescent paint will glow, causing a pleasing effect.

The layers of mouse pad 200 may be any convenient thickness. However, in many embodiments of mouse pad 200, reflective layer 120 is thinner than top layer 125 and top layer 125 is thinner than base 110. In some embodiments of optical mouse pad 200, reflective layer 120 is in the range of 0.005 to 0.010 inches, top layer 125 is in the range of 0.010 to 0.05 inches and base 110 is in the range of 0.1 to 0.25 inches.

In the embodiment illustrated in FIG. 2, top layer 125 is formed of material which is substantially transparent to the frequencies of light emitted by the optical mouse to be used with the pad. As noted above, materials used to fabricate some such embodiments of top layer 125 include, but are not limited to, polycarbonate, Mylar, LEXAN™ material, lacquer, polyurethane, acetate and plastics such as polyvinyl chloride.

Reflective layer 120 may be formed of a variety of reflective materials, such as polyvinyl chloride or other plastic material, a metal such as aluminum, silver or gold, or any other convenient reflective material. In some embodiments, the reflective constituents of reflective layer 120 are dispersed in a paint or similar material and applied to base 110, to top layer 125 or to another layer.

In some embodiments, reflective layer 120 is formed of reflective sheeting such as SCOTCHLITE™ Reflective Sheeting 550-10U. Reflective sheeting is normally manufactured with a first side which is designed to face incident light (a/k/a/ “the reflective side”) and a second adhesive side. Reflective sheeting is normally sold with the adhesive side in contact with a non-stick backing material, such as polyethylene-coated paper. The recommended use of reflective sheeting is to peel away the backing in order to apply the adhesive side to a desired surface, such as a wall, a sign, an article of manufacture, etc. Consequently, the reflective side is normally facing the incident light and the adhesive side is normally facing away from the incident light.

In some preferred embodiments of optical mouse 200, reflective sheeting is used in a way very different from the conventional manner of use. In such embodiments of optical mouse 200, upper surface 205 of reflective layer 120 is the adhesive side of such reflective sheeting and lower surface 215 is the reflective side of the sheeting. In these embodiments, despite the fact that lower surface 215 is designed to face incident sources of light, lower surface 215 is attached to base 110 and faces away from incident light 230. Upper surface 205 is configured to face and reflect incident light 230 from optical mouse 235.

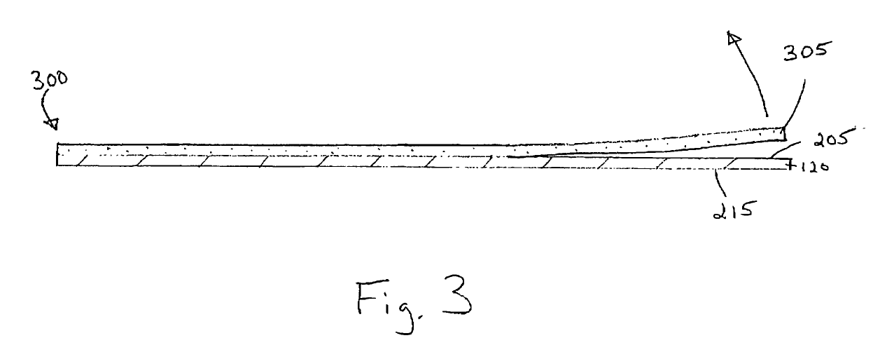

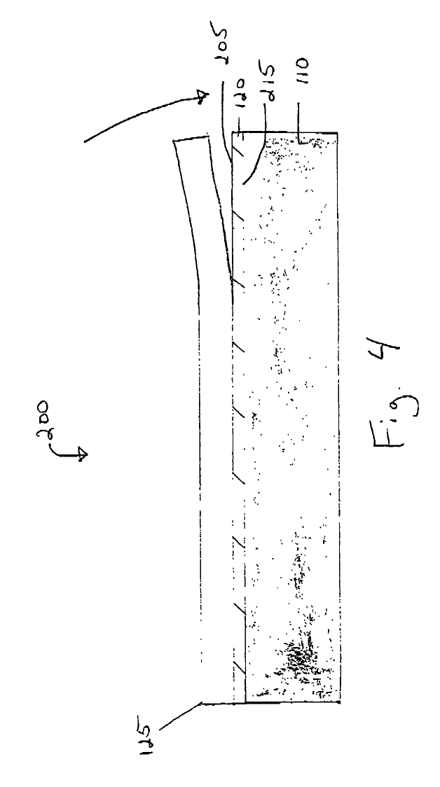

FIGS. 3 and 4 illustrate a method of fabricating optical mouse 200 from reflective sheeting, a top layer and a base layer. As illustrated in FIG. 3, the first step is to peel away backing 305 from reflective layer 120, thereby exposing adhesive side 205. As noted above, adhesive side 205 would normally be applied to an opaque surface and reflective side 215 would be exposed to incident light.

However, as illustrated in FIG. 4, one method of forming optical mouse pad 200 is to apply substantially transparent top layer 125 to adhesive side 205 and (optionally) to apply reflective side 215 to base 110. Referring to FIG. 2 and Table 1, it may be seen that adhesive side 205 has sufficient reflectivity and “graininess” to provide a very good surface for reflecting incident light 230 from mouse 235.

In FIG. 1, top layer 125 is shown to be laterally uniform across the top surface of optical mouse pad 100. However, some embodiments of top layer 125 vary laterally in color, texture and/or material.

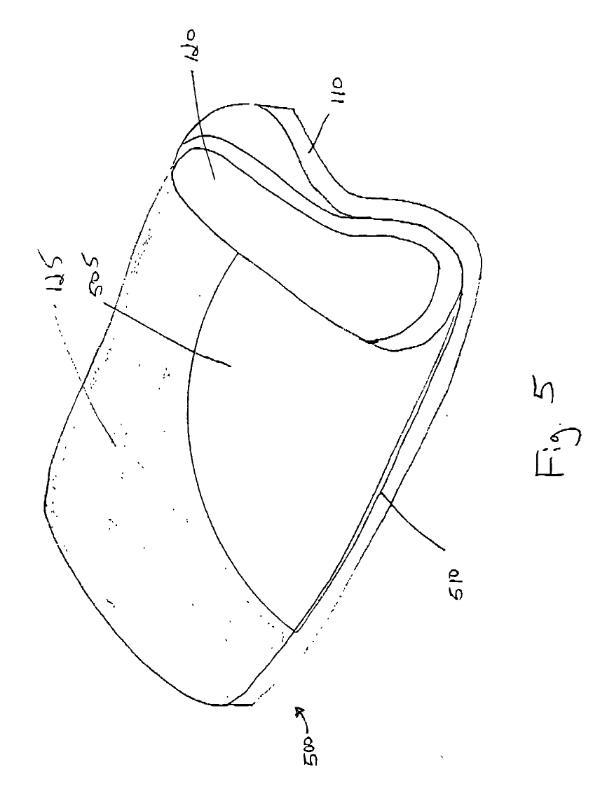

One such embodiment is optical mouse pad 500, illustrated in FIG. 5. Optical mouse pad 500 includes a laterally varying top layer 125, one portion of which is formed into a shape which approximates a quarter circle. Within this shape, top layer 125 is formed of transparent material 505 with reflective silver material 510 underneath. Other embodiments of optical mouse pad 500 include other variations of materials, shape, color, texture and reflectivity within top layer 125 and, in some cases, nearby layers. Lateral variations in top layer 125 create many possibilities for designs which may appeal to consumers.

Tests were conducted in order to evaluate the performance of various embodiments of the optical mouse pad of the present invention. Kensington's Black Gel Pad was used as a background and control surface. A task lamp was placed approximately 10 inches away from each material tested, with the light of the task lamp directed downward. The optical mouse used in the experiments was a Logitech MOUSEMAN™ optical mouse. The optical mouse was tested while moving and while using the brightest mode of its LED.

Tektronix 2-channel digital oscilloscope was used to test the optical mouse's battery life. Various materials were placed on the mouse pad and tested with the oscilloscope. For each material, the elapsed time for the optical mouse to open its shutter was recorded. This time indicates how many times the LED needs to flash before the movement of the mouse is registered.

A Fluke multimeter was used to measure the current drawn by the LED of the optical mouse when light from the LED was reflected from the materials tested. This measurement allows a prediction of power consumption and battery usage.

Therefore, in terms of both precise tracking and lower power consumption, a relatively smaller time indicates a relatively better material for use in an optical mouse. The results are set forth below in Table 1.

TABLE 1

| | Shutter | |
|---|---|---|
| | Opening Time | |
| Material | (Microseconds) | Comments |
| KTG Black Gel Pad | 496 | |
| one sheet of white paper (small texture) | 96 | |
| one sheet of gloss white paper (high | 86.4 | |
| texture) | | |
| ten sheets of white paper (small texture) | 86.6 | |
| ten sheets of white paper under lexan | 100 | fine texture |
| 0.010″ | | |
| ten sheets of white paper under lexan | 90.4 | rougher texture |
| 0.050″ | | |
| ten sheets of white paper under lexan | 98.4 | smooth texture |
| 0.020″ | | |
| white lycra | 78 | |
| white lycra with 0.015″ lexan | 103 | |
| white lycra, folded over twice with | 86.4 | |
| 0.015″ lexan | | |
| red lycra | 87 | |
| red lycra with lexan 0.015″ | 100 | |
| Hologram clear on black gel | 498 | |
| homogram with 10 white paper sheets | 126 | |
| KTG's Hypermood mouse pad | 400 | |
| Reflective material white | 125 | |
| Reflective material white upside down | 88 | |
| with lexan 0.015″ | | |
| Blue anti-static bag | 400 | |
| Blue anti-static bag with 10 white paper | 248 | |
| sheets | | |
| Formica - spectrum red | 121 | |
| Formica - ice white | 87.2 | |
| Glow in the dark stars | 141 | |
| white board material | 87.2 | |
| white melamine shelving | 78 | |
| 3m Precise mousing surface | 218 | |
| Red paint on back of acetate | 198 | |
| Birch wood | 90 | |
| Phosphorescent ink (glowing) under | 148 | |
| Lexan | | |
| Phosphorescent ink (glowing) under | 88 | |
| Lexan + white paper placed under 10 | | |
| sheets of white paper | | |

A subsequent test conducted with the same parameters yielded the following results

TABLE 2
Mouse Pad Test Results

| | Stutter Opening | | |
|---|---|---|---|
| Materials/Texture Patterns | Microseconds | NEW | |
| KTG's Black Gel Pad | 496 | 489 | |
| ten sheets of white paper (small | 86.6 | 76 | |
| texture) | | | |
| printed/stamped silver surface | 140 | | New Test |
| printed/stamped gold surface | 150 | | New Test |
| injection molded silver surface | 190 | | New Test |

The test results indicated a large jump in shutter opening/closing with various materials. The most dramatic contrast is between the black gel pad (496 μs) and the lighter-colored surfaces (generally around 100 μs). There are numerous materials and material variations in the 80 μs to 100 μs range. Therefore, among the materials in this range, the relative desirability of materials is based on design aesthetics and the ease of manufacture of the material selected.

The results unexpectedly indicated that reflective material works better when used with the adhesive side up and covered with a layer of transparent material (88 μsec) than when the outer “reflective” side is up (125 μsec).

Battery Consumption Results

As noted above, the relative power consumption and consequent battery usage was also tested for each material in the 80 ms to 100 ms range. The Logitech MOUSEMAN™ optical mouse requires 41-42 mA of current when used on a black mouse pad. The lighter-colored materials (in the 80 ms to 100 ms zone) were found to require 28-29 mA of current. Accordingly, a black pad would drain the batteries of a wireless optical mouse nearly 50% faster than would a lighter-colored pad, according to the following formula:

$$\frac{41 mA ( black surface ) - 28 mA ( light surface )}{28 mA ( light surface )} \times 100 = 46.4 \%$$

Although the present invention has been described with reference to specific exemplary embodiments, it will be appreciated that it is intended to cover all modifications and equivalents within the scope of the appended claims.

What is claimed is:

1. An optical mouse pad, comprising:
a first layer of reflective sheeting; and
a second layer attached to the first layer, at least a portion of the second layer being substantially transparent to light emitted by an optical mouse.

2. The optical mouse pad of claim 1, wherein the first layer comprises a first side and a second side, wherein the first side comprises an adhesive and wherein the adhesive attaches the first side to the second layer.

3. The optical mouse pad of claim 1, wherein the first layer comprises a metallic material.

4. The optical mouse pad of claim 1, wherein the second layer comprises a material selected from the group consisting of polyvinyl chloride, polycarbonate and LEXAN™ material.

5. The optical mouse pad of claim 1, wherein the second layer has a thickness in the range of 0.01 to 0.05 inches.

6. The optical mouse pad of claim 1, further comprising a third layer attached to the first layer, the third layer providing an anti-skid base for the optical mouse pad.

7. The optical mouse pad of claim 1, further comprising a wrist pad along at least a side of the optical mouse pad.

8. The optical mouse pad of claim 6, wherein at least a portion of the third layer is formed of rubber.

9. The optical mouse pad of claim 6, the first layer comprises a first side and a second side, wherein the first side comprises an adhesive and the second side is designed to be an outer surface, and wherein the third layer is attached to the second side of the first layer.

10. An optical mouse pad, comprising:
a first layer of reflective sheeting comprising a first side designed to be an outer portion and a second adhesive side;
a second substantially transparent layer attached to the second side of the first layer.

11. A method of fabricating a pad for use with an optical mouse from reflective sheeting comprising a first side designed to face incident light, a second side comprising an adhesive portion and a layer of backing attached to the second side, the method comprising the steps of:
removing the backing from the second side; and
attaching a substantially transparent layer to the second side.

12. The method of claim 11, further comprising the step of attaching an anti-skid layer to the first side.

13. The method of claim 11, wherein the attaching step comprises pressing the transparent layer against the adhesive portion of the second side.

14. The method of claim 13, wherein the anti-skid layer comprises rubber.
